(19) United States
(12) Patent Application Publication
(10) Pub. No.: US 2015/0161959 A1
(43) Pub. Date: Jun. 11, 2015

(54) Driving Method and Driving Device thereof

(71) Applicant: NOVATEK Microelectronics Corp., Hsin-Chu (TW)

(72) Inventors: Chin-Hung Hsu, Taoyuan County (TW); Yu-Ming Chang, Taichung City (TW); Chao-Chih Hsiao, Taipei City (TW); Po-Ching Li, Hsinchu City (TW)

(21) Appl. No.: 14/531,931

(22) Filed: Nov. 3, 2014

(30) Foreign Application Priority Data
Dec. 6, 2013 (TW) 102144907

(51) Int. Cl. G09G 3/36

(52) U.S. Cl. CPC G09G 3/3674; G09G 2330/12; G09G 2330/08; G09G 2310/0264

(57) ABSTRACT

A driving method for a display system with a gate driving device and a panel includes utilizing a plurality of gate driving modules of the gate driving device to generate a plurality of gate driving signals for driving a plurality of scan lines of the panel; and adjusting a plurality of output resistances of the plurality of gate driving modules according to the plurality of gate driving signals.

### BACKGROUND OF THE INVENTION

1. Field of the Invention

The present invention relates to a driving method and driving device thereof, and more particularly, to a driving method capable of adaptively adjusting the output resistances of the gate drivers and driving device thereof.

2. Description of the Prior Art

The advantages of a liquid crystal display (LCD) include light weight, low electrical consumption, and low radiation contamination. LCD monitors have been widely applied to various portable information products, such as notebooks and PDAs. In an LCD monitor, incident light produces different polarization or refraction effects when the alignment of liquid crystal cells is altered. The transmission of the incident light is affected by the liquid crystal molecules, so that a magnitude of the light emitting out of liquid crystal molecules varies. The LCD monitor utilizes the characteristics of the liquid crystal molecules to control the corresponding light transmittance and produce images according to different magnitudes of red, blue, and green light.

Please refer to FIG. 1, which is a schematic diagram of a conventional thin film transistor (TFT) LCD 10. The TFT LCD 10 comprises a panel 100, a gate driving device 102 and a source driving device 104. The panel 100 comprises scan lines SL1-SLn and data lines DL1-DLm, wherein each intersections of the scan lines SL1-SLn and the data lines DL1-DLm is coupled to a transistor MN coupled to the capacitors CS and CL, separately. The gate driving device 102 is utilized for generating gate driving signals Y1-Yn, to sequentially enable the scan lines SL1-SLn of the panel 100. The source driving device 104 is utilized for outputting corresponding data signals D1-Dm to the data line DL1-DLm of the panel 100. Accordingly, the TFT LCD can sequentially control the voltage difference cross the equivalent capacitor of each liquid crystal molecules.

When enabling a scan line SLa of the scan lines SL1-SLn, the gate driving device 102 adjusts a gate driving signal Ya of the gate driving signals Y1-Yn corresponding to the scan line SLa to a high voltage level VGH and adjusts driving signals corresponding to other scan lines to a low voltage level VGL. However, the data signals D1-Dm may couple to the scan lines SL1-SLn via the parasitic capacitors between the data lines DL1-DLm and the scan lines SL1-SLn (e.g. the capacitor C1 shown in FIG. 1) when the source driving device 104 outputs the data signals D1-Dm, such that the gate driving device is affected and may work abnormally. Thus, how to reduce the interference generated from the source driving device 104 to the gate driving device 102 via the parasitic capacitors becomes an issue to be discussed.

### SUMMARY OF THE INVENTION

In order to solve the above problem, the present invention provides a driving method capable of adaptively adjusting the output resistances of the gate drivers and driving device thereof.

The present invention discloses a driving method for a display system with a gate driving device and a panel, the driving method comprising utilizing a plurality of gate driving modules of the gate driving device to generate a plurality of gate driving signals for driving a plurality of scan lines of the panel; and adjusting output resistances of the plurality of gate driving modules according to the plurality of gate driving signals.

The present invention further discloses a driving device for a display system with a panel, the driving device comprising a plurality of gate driving modules, for generating a plurality of gate driving signals utilized for driving a plurality of scan lines of the panel; and a control unit, for adjusting a plurality output resistances of the plurality of gate driving modules according to the plurality of gate driving signals.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional thin film transistor liquid crystal display.

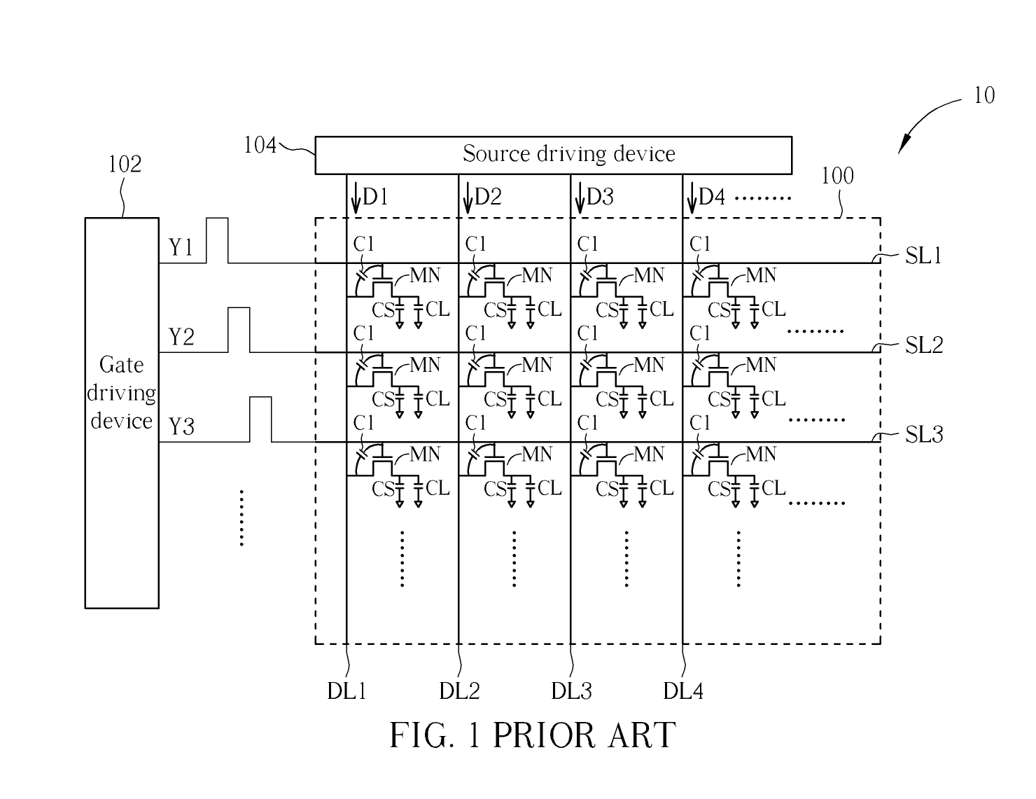

FIG. 2 is a schematic diagram of a display system according to an embodiment of the present invention.

FIG. 3 is a timing diagram of related signals when the display system shown in FIG. 2 operates.

FIG. 4 is another timing diagram of related signals when the display system shown in FIG. 2 operates.

FIG. 5 is still another timing diagram of related signals when the display system shown in FIG. 2 operates.

FIG. 6 is a schematic diagram of a realization method of the gate driving unit shown in FIG. 2.

FIG. 7 is a flow chart of a driving method according to an embodiment of the present invention.

### DETAILED DESCRIPTION

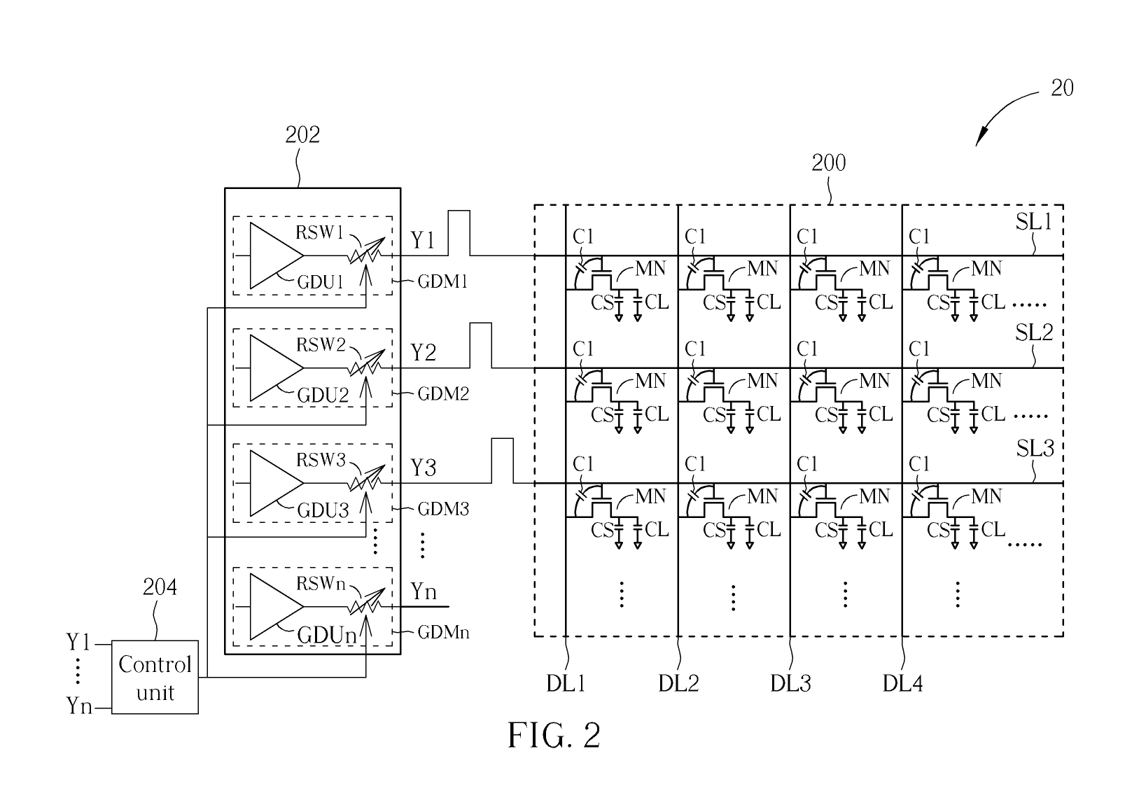

Please refer to FIG. 2, which is a schematic diagram of a display system 20 according to an embodiment of the present invention. The display system 20 may be a thin film transistor (TFT) liquid crystal display (LCD) and the structure or the detailed composing method of the display system 20 may be different according to different applications. A panel 200, a gate driving device 202 and a control unit 204 of the display system 20 are shown in FIG. 2 for illustration and the components which does not directly relate to the concept of the present invention, such as the housing, the source driving device, and the connection interface, are not shown in FIG. 2 for brevity. The panel 200 comprises scan lines SL1-SLn and data lines DL1-DLm, wherein each intersection of the scan lines SL1-SLn and the data lines DL1-DLm couples to a transistor MN and the transistor MN couples to the capacitors CS and CL. The operating principle of the panel 200 should be well-known to those with ordinary skill in the art, and is not narrated herein for brevity. The gate driving device 202 comprises gate driving modules GDM1-GDMn, for generating gate driving signals Y1-Yn to drive the scan lines SL1-SLn. The control unit 204 is utilized for adjusting the output resistances of the gate driving modules GDM1-GDMn according to the gate driving signals Y1-Yn, separately, to reduce the effect generated from the signals of the data lines DL1-DLm to the scan lines SL1-SLn. The display system 20 therefore can avoid working abnormally.

In details, the gate driving module GDM1-GDMn comprises gate driving units GDU1-GDUn and variable resistors RSW1-RSWn. The gate driving units GDU1-GDUn are coupled to the variable resistors RSW1-RSWn for generating the gate driving signals Y1-Yn to sequentially enable the scan lines SL1-SLn. When the gate driving device 202 is required to enable a scan line SLa of the scan lines SL1-SLn, agate driving unit GDUa of the gate driving units GDU1-GDUn adjusts the gate driving signal Ya to a high voltage level VGH and the other gate driving units adjust the other driving signals to a low voltage level VGL. In order to allow the gate driving unit GDUa to rapidly adjust the gate driving signal Ya to the high voltage level VGH, the control unit 204 adjusts the resistance of the variable resistor RSWa coupled to the gate driving unit GDUa to a resistance R1 (e.g. lowering the resistance of the variable resistor RSWa to the resistance close to short circuit). At the same time, the control unit 204 adjusts the resistances of the variable resistors coupled to the other gate driving units to a resistance R2 (e.g. heightening the resistances of the variable resistors coupled to the other gate driving units to the resistance close to open circuit), for reducing the effect generated from the signals of the data lines DL1-DLm to the low voltage level VGL of the other gate driving signals.

Next, when the gate driving device 202 is switched from enabling the scan line SLa to enabling a next scan line SLb, the control unit 204 keeps the resistance of the variable resistor RSWa at the resistance R1 since the voltage of the gate driving signal Ya needs to be rapidly adjusted from the high voltage level VGH to the low voltage level VGL. In other words, the control unit 204 adjusts the output resistance of the gate driving unit GDUa (i.e. the resistance of the variable resistor RSWa) to the resistance R1 when the gate driving signal Ya is switched from the low voltage level VGL to the high voltage level VGH, for enhancing the driving ability of the gate driving unit GDUa. The gate driving unit GDUa therefore can change the gate driving signal Ya rapidly. The control unit also adjusts the resistances of the output resistor of the other gate driving units to the resistance R2, for preventing the gate driving device 202 from being affected by the signals of the data lines DL1-DLm. Please note that, if a gate driving unit GDUx is required to switch a gate driving signal Yx from the high voltage level VGH to the low voltage level VGL at the same time (i.e. stop enabling the scan line drove by the gate driving signal Yx), the control unit 204 keeps the output resistance of the gate driving unit GDUx (i.e. the variable resistor RSWx) to the resistance R1 for a certain time and then adjusts the output resistance of the gate driving unit GDUx to the resistance R2, for ensuring that the gate driving unit GDUx can rapidly change the gate driving signal Yx from the high voltage level VGH to the low voltage level VGL. As a result, the control unit 204 adjusts the resistance of the variable resistor RSW1-RSWn according to the voltage changes of the gate driving signal Y1-Yn, so as to avoid the display system 20 working abnormally.

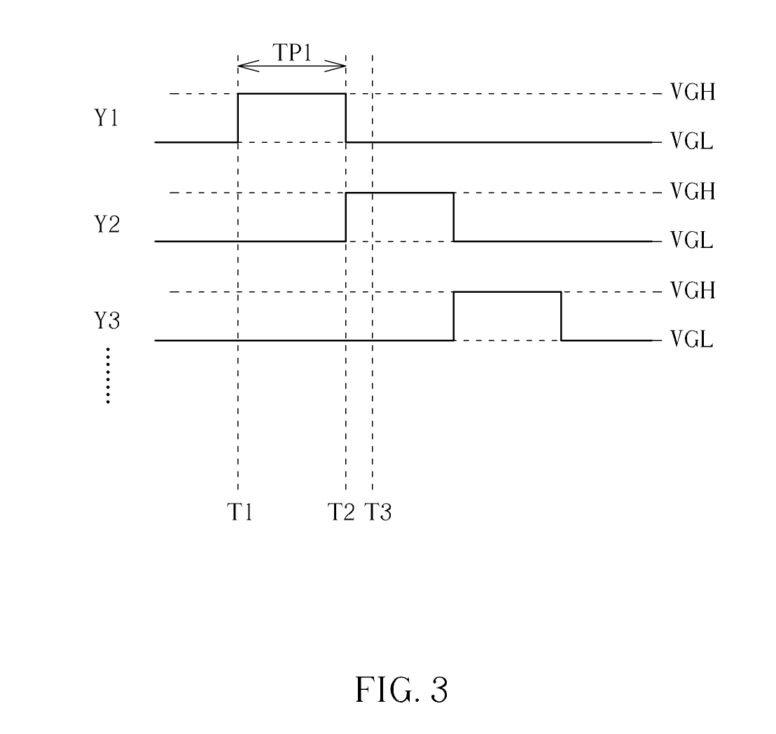

Please refer to FIG. 3, which is a timing diagram of related signals when the display system 20 shown in FIG. 2 operates. FIG. 3 only shows the gate driving signals Y1-Y3 for illustration. As shown in FIG. 3, the control unit 204 adjusts the resistance of the variable resistor RSW1 to the resistance R1 when the gate driving unit GDU1 is required to increase the gate driving signal Y1 to the high voltage level VGH at a time T1, to enhance the driving ability of the gate driving unit GDU1. The control unit 204 also adjusts the resistances of the variable resistors RSW2-RSWn to the resistance R2 for decreasing the driving abilities of the gate driving units GDU2-GDUn, so as to reduce the effect generated from the signals of the data lines DL1-DLm to the scan lines SL2-SLn. Next, when the gate driving unit GDU1 is required to decrease the gate driving signal Y1 to the low voltage level VGL and the gate driving unit GDU2 is required to increase the gate driving signal Y2 to the high voltage level VGH at a time T2, the control unit 204 adjusts the resistance of the variable resistor RSW2 to the resistance R1 and the resistances of the variable resistors RSW3-RSWn is kept at the resistance R2. Please note that, the control unit 204 adjusts the resistance of the variable resistor RSW1 to the resistance R2 at a time T3 after the time T2, for ensuring that the gate driving unit GDU1 equips with enough driving ability to decrease the gate driving signal Y1 from the high voltage level VGH to the low voltage level VGL rapidly. Accordingly, the driving ability of the gate driving unit GDU2 is enhanced and the driving abilities of the gate driving units GDU1 and GDU3-GDUn is decreased, so as to reduce the effects generated from the signals of data lines DL1-DLm to the scan lines SL1 and SL3-SLn. That is, the control unit 204 adjusts the resistance of the variable resistor to the resistance R1 in a time period after the gate driving signal coupled to the variable resistor instructs enabling the scan line (e.g. the time period TP1 between the times T1 and T2) and another time period after the gate driving signal instructs stopping enabling the scan line (e.g. the time period between the times T2 and T3), for making the scan line be normally drove. The control unit 204 keeps the resistances of the other variable resistors at the resistance R2, to reduce the interference generated from the data lines DL1-DLm to the scan lines SL1-SLn. The display system 20 can avoid working abnormally, therefore.

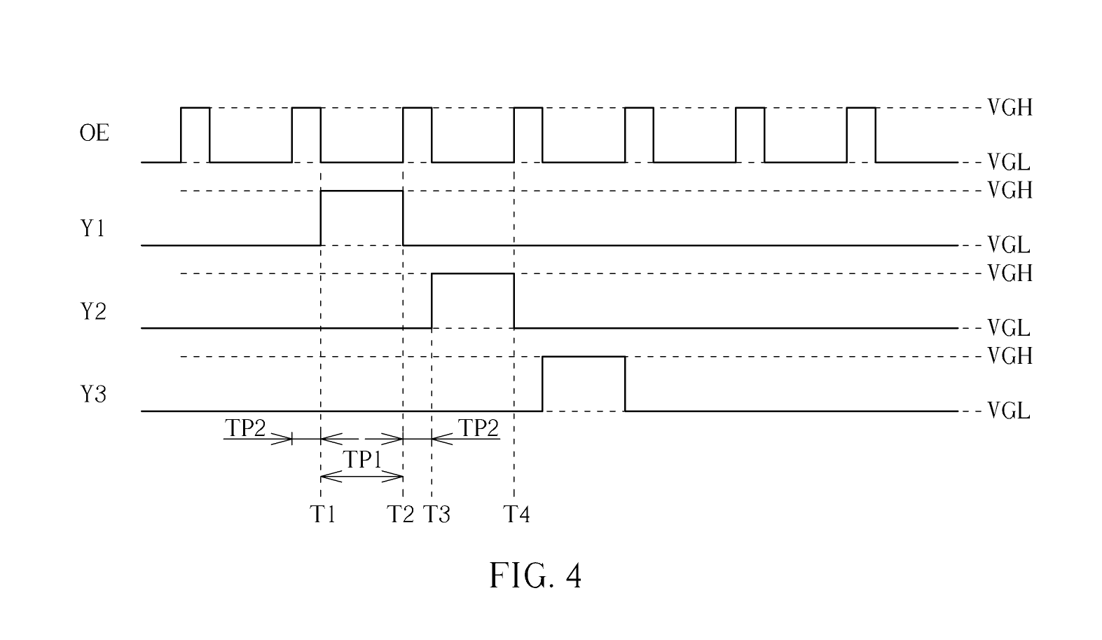

According to different design concepts and applications, the display system 20 may use different signals to adjust the output resistances of the gate driving units GDU1-GDUn. Please refer to FIG. 4, which is another timing diagram of related signals when the display system 20 shown in FIG. 2 operates. FIG. 4 only shows the gate driving signals Y1-Y3 for illustration. As shown in FIG. 4, in order to avoid two scan lines being enabled at the same time due to delays of the gate driving signals Y1-Yn, the display system 20 uses a signal OE to control the gate driving device 202 for interleaving the times of the adjacent gate driving signals of the gate driving signals Y1-Yn (e.g. the gate driving signals Y1 and Y2) instruct enabling the scan lines (i.e. the time of simultaneously keeping at the high voltage level VGH) for a time period TP2. When the gate driving unit GDU1 is required to increase the gate driving signal Y1 to the high voltage level VGH at the time T1, the control unit 204 adjusts the resistance of the variable resistor RSW1 to the resistance R1, to enhance the driving ability of the gate driving unit GDU1 and make the gate driving signal Y1 be increased to the high voltage level VGH rapidly. The control unit 204 also adjusts the resistances of the variable resistors RSW2-RSWn to the resistance R2 for decreasing the driving abilities of the gate driving units GDU2-GDUn, so as to reduce the effect generated from the signals of data lines DL1-DLm to the scan lines SL2-SLn. Next, when the gate driving unit GDU1 is required to decrease the gate driving signal Y1 to the low voltage level VGL at the time T2, the control unit 204 keeps the resistance of the variable resistor RSW1 at the resistance R1 for the time period TP2 and keeps the resistances of the variable resistors RSW2-RSWn at the resistance R2. That is, the control unit 204 adjusts the resistance of the variable resistor GSW1 to the resistance R1 and adjusts the resistances of the variable resistors RSW2-RSWn to the resistance R2 for a time period subsequent to the time of the gate driving signal Y1 begins enabling the scan line SL1 (e.g. the time period TP1 plus the time period TP2 shown in FIG. 4)

Similarly, when the gate driving unit GDU2 is required to increase the gate driving signal Y2 to the high voltage level VGH at the time T3, the control unit 204 adjusts the resistance of the variable resistor RSW2 to the resistance R1, to enhance the driving ability of the gate driving unit GDU2 and make the gate driving signal Y2 be increased to the high voltage level VGH rapidly. The control unit 204 also adjusts the resistances of the variable resistors RSW1 and RSW3-RSWn to the resistance R2 for decreasing the driving abilities of the gate driving units GDU1 and GDU3-GDUn, so as to reduce the effect generated from the signals of data lines DL1-DLm to the scan lines SL1 and SL3-SLn. Next, when the gate driving unit GDU2 is required to decrease the gate driving signal Y2 to the low voltage level VGL at the time T4, the control unit 204 keeps the resistance of the variable resistor RSW2 at the resistance R1 for the time period TP2 and keeps the resistances of the variable resistors RSW1 and RSW3-RSWn at the resistance R2, and so on. As a result, the effect generated from the signals of the data lines DL1-DLm to the gate driving device 202 can be reduced and the display system 20 can avoid working abnormally.

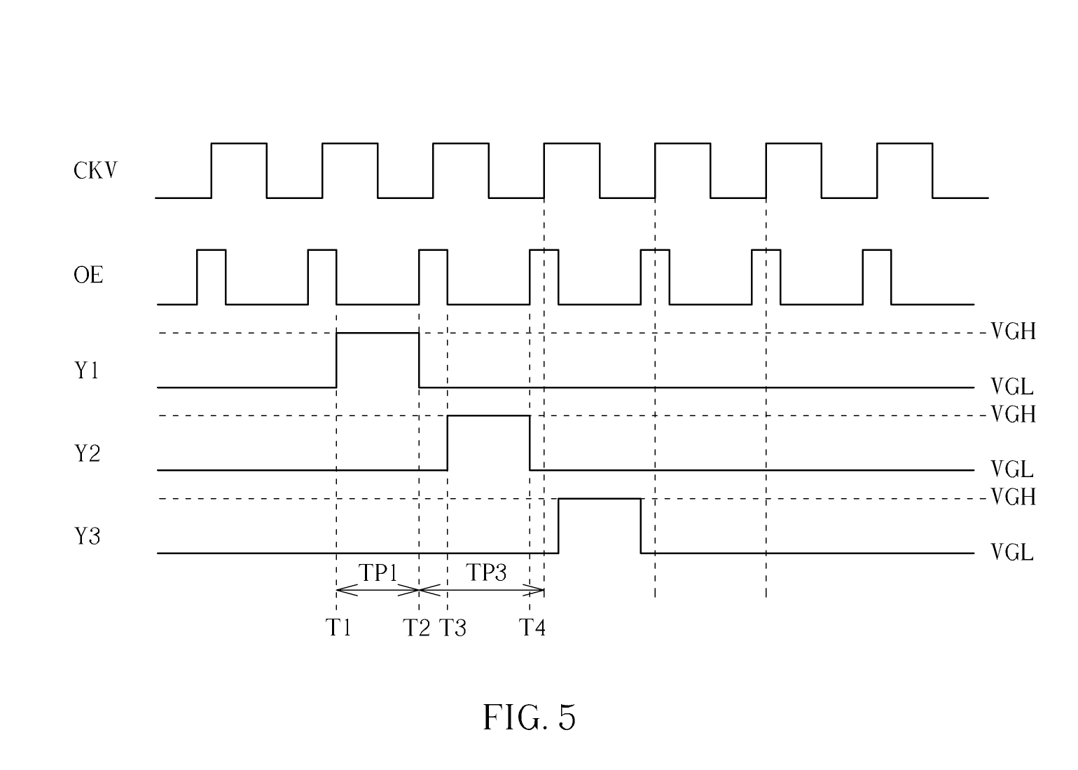

Please refer to FIG. 5, which is still another timing diagram of related signals when the display system 20 shown in FIG. 2 operates. FIG. 5 only shows the gate driving signals Y1-Y3 for illustration. Similar to FIG. 4, in order to avoid two scan lines being enabled at the same time due to delays of the gate driving signals Y1-Yn, the display system 20 use a signal OE to interleave the times of the adjacent gate driving signals enable the scan lines. When the gate driving unit GDU1 is required to increase the gate driving signal Y1 to the high voltage level VGH at the time T1, the control unit 204 adjusts the resistance of the variable resistor RSW1 to the resistance R1, to enhance the driving ability of the gate driving unit GDU1 and make the gate driving signal Y1 be increased to the high voltage level VGH rapidly. The control unit 204 also adjusts the resistances of the variable resistors RSW2-RSWn to the resistance R2 for decreasing the driving abilities of the gate driving units GDU2-GDUn, so as to reduce the effects generated from the signals of data lines DL1-DLm to the scan lines SL2-SLn. Different from FIG. 4, when the gate driving unit GDU1 is required to decrease the gate driving signal Y1 to the low voltage level VGL at the time T2, the control unit 204 keeps the resistance of the variable resistor RSW1 at the resistance R1 for the time period TP3 according to a clock signal CKV (e.g. the time of the time T2 plus a period of the clock signal CKV), for making the gate driving signal Y1 be adjusted from the high voltage level VGH to the low voltage level VGL rapidly.

Next, when the gate driving unit GDU2 is required to increase the gate driving signal Y2 to the high voltage level VGH at the time T3, the control unit 204 adjusts the resistance of the variable resistor RSW2 to the resistance R1, to enhance the driving ability of the gate driving unit GDU2 and make the gate driving signal Y2 be increased to the high voltage level VGH rapidly. The control unit 204 also adjusts the resistances of the variable resistors RSW3-RSWn to the resistance R2 for decreasing the driving abilities of the gate driving units GDU3-GDUn, so as to reduce the effects generated from the signals of data lines DL1-DLm to the scan lines SL3-SLn. Please note that, since the time T3 is within the time period TP3 subsequent to the time T2, the resistance of the variable resistor RSW1 remains the resistance R1. Till the time period TP3 ends, the control unit 204 adjusts the resistance of the variable resistor RSW1 to the resistance R2. As a result, the effects generated from the signals of the data lines DL1-DLm to the gate driving device 202 can be reduced and the display system 20 can avoid working abnormally.

Noticeably, the above embodiments reduce the interferences generated from the signals of the data lines to the gate driving device via adaptively adjusting the output resistances of the gate driving device utilized for driving the scan lines. The display system therefore can avoid working abnormally. According to different applications and design concepts, those with ordinary skill in the art may observe appropriate alternations and modifications. For example, please refer to FIG. 2. When the gate driving signal Ya of the gate driving signals Y1-Yn is switched from the low voltage level VGL to the high voltage level VGH and the gate driving signal Yx is switched from the high voltage level VGH to the low voltage level VGL, the control unit 204 adjusts the output resistances of the gate driving units GDUa and GDUx (i.e. the resistance of the variable resistors RSWa and RSWx), which generates the gate driving signals Ya and Yx, to the resistance R1. According to different applications, the number of the variable resistors, the resistances of which are adjusted by the control unit 204 to the resistance R2, among the variable resistors of the remaining gate driving units (i.e. the variable resistors RSW1-RSWn subtract the variable resistors RSWa and RSWx) can be changed. For example, the control unit 204 may adjust the resistance of half of the variable resistors of the remaining gate driving units to the resistance R2 and the goal of reducing the interference generated from the signals of data lines to the gate driving device also can be achieved.

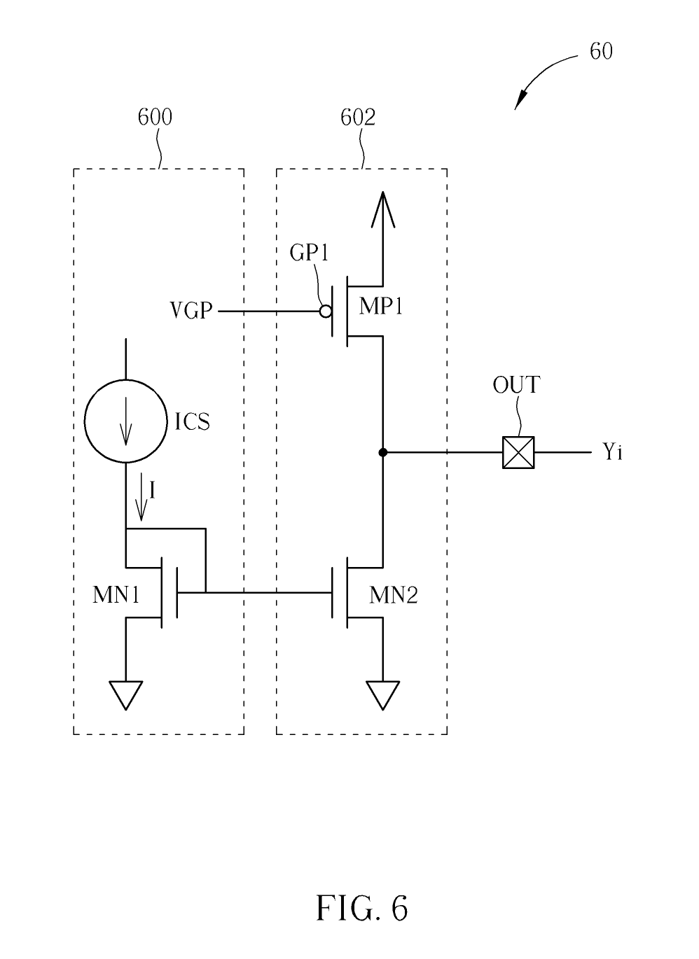

Please refer to FIG. 6, which is a schematic diagram of a gate driving unit 60 according to an embodiment of the present invention. The gate driving unit 60 is another implementation method of the gate driving units GDU1-GDUn shown in FIG. 2, and is utilized for generating one of the gate driving signals Y1-Yn (which is shown as a gate driving signal Yi in FIG. 6). As shown in FIG. 6, the gate driving unit 60 comprises a control unit 600 and an output stage 602. The control unit 600 is utilized for controlling the output stage 602 to generate the gate driving signal Yi at an output end OUT, for driving the corresponded scan line. In addition, the control unit 600 adjusts the output resistance of the output stage 602 according to an external control signal (e.g. the control signal outputted by the control unit 204 shown in FIG. 2), to reduce the effects generated from the signals of the data lines to the gate driving unit 60. In this embodiment, the control unit 600 comprises a current source ICS and a transistor MN1 and the output stage 602 comprises transistors MN2 and MP1, wherein the transistors MN1 and MN2 form a current mirror for generating a current equivalent to the current I generated by the current source ICS. Via adjusting the control signal VGP coupled to the gate GP1 of the transistor MP1, the control unit 600 can adjusts the voltage of the gate driving signal Yi. Besides, the control unit 600 also can change the current I generated by the current source ICS according to the external control signal (not shown in FIG. 6), so as to adjust the output resistance of the output stage 602. For example, when the control unit 600 decreases the current I generated by the current source ICS, the conducting resistance of the transistor MN1 increases. The output resistance of the output stage 602 increases, therefore. Similarly, when the control unit 600 increases the current I generated by the current source ICS, the conducting resistance of the transistor MN1 decreases. The output resistance of the output stage 602 therefore decreases. As a result, the gate driving unit 60 can be utilized for generating the gate driving signal Yi and the output resistance of the gate driving unit 600 can be appropriately adjusted. The goal of reducing the effects generated from the signals of the data lines to the gate driving unit 60 can be achieved.

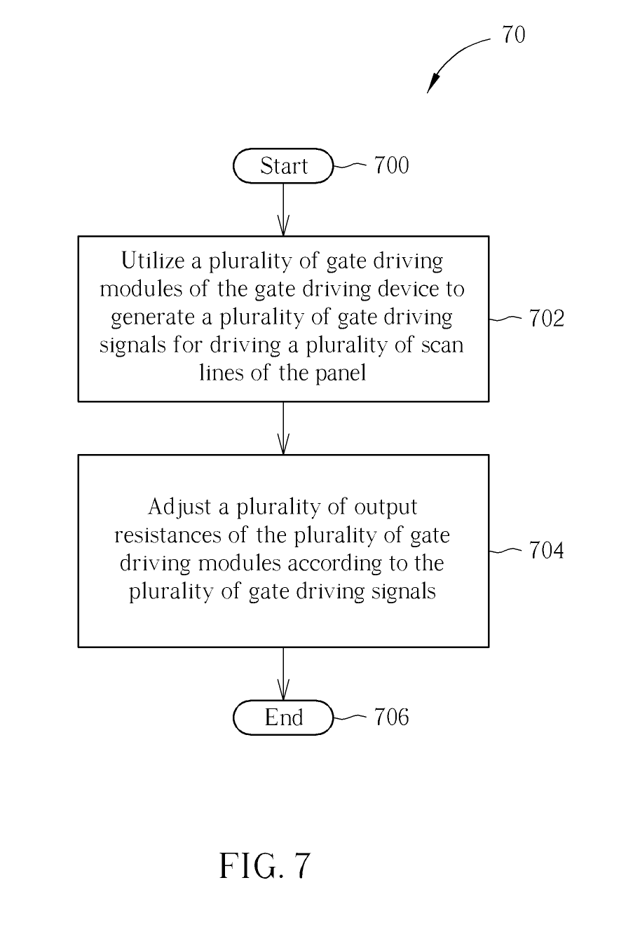

The method of the control unit 204 adjusting the gate driving device 202 can be summarized into a driving method 70, as shown in FIG. 7. The driving method 70 can be utilized in a display system with a gate driving device and a panel, and comprises the following steps:

Step 700: Start.

Step 702: Utilize a plurality of gate driving modules of the gate driving device to generate a plurality of gate driving signals for driving a plurality of scan lines of the panel.

Step 704: Adjust a plurality of output resistances of the plurality of gate driving modules according to the plurality of gate driving signals.

Step 706: End.

According to the driving method 70, the gate driving device of the display system can avoid being effected by other signals. The detailed operations of the driving method 70 can be referred to the above, and are not narrated herein for brevity.

To sum up, the driving method and gate driving device comprising it of the above embodiments adaptively adjust the output resistance of the gate driving device coupled to the scan lines, to avoid the signals of the data lines in the display system effect the gate driving device via the parasitic capacitors. Therefore, the effects generated from the signals of the data lines to the gate driving device are reduced and the display system avoids working abnormally.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving method for a display system with a gate driving device and a panel, the driving method comprising:
utilizing a plurality of gate driving modules of the gate driving device to generate a plurality of gate driving signals for driving a plurality of scan lines of the panel; and
adjusting a plurality of output resistances of the plurality of gate driving modules according to the plurality of gate driving signals.

2. The driving method of claim 1, wherein the step of adjusting an output resistance of each of the plurality of gate driving modules according to the plurality of gate driving signals comprises:
lowering the output resistance of a first gate driving module of the plurality of gate driving modules for a first period when a first gate driving signal generated by the first gate driving module enables a first scan line of the plurality of scan lines.

3. The driving method of claim 2, wherein the output resistance of the first gate driving module is lowered to a resistance of short circuit for the first period.

4. The driving method of claim 2, further comprising:
lowering the output resistance of a second gate driving module of the plurality of gate driving modules for a second period when a second gate driving signal generated by the second gate driving module disables a second scan line of the plurality of scan lines.

5. The driving method of claim 4, wherein the output resistance of the second gate driving module is lowered to a resistance of short circuit for the second period.

6. The driving method of claim 4, further comprising:
heightening the output resistances of a plurality of third gate driving modules among the plurality of gate driving modules;
wherein the plurality of third gate driving modules does not comprise the first gate driving module and the second gate driving module.

7. The driving method of claim 6, wherein the step of heightening the output resistances of the plurality of third gate driving modules among the plurality of gate driving modules comprises:
heightening the output resistances of the plurality of third gate driving modules to resistances of open circuit.

8. The driving method of claim 1, wherein step of adjusting the output resistance of each of the plurality of gate driving modules according to the plurality of gate driving signals comprises:
adjusting the resistance of a variable resistor coupled to one of the plurality gate driving signals in each of the plurality of gate driving modules according to the plurality of gate driving signals, for adjusting the output resistance of each of the plurality of gate driving modules.

9. The driving method of claim 1, wherein step of adjusting the output resistance of each of the plurality of gate driving modules according to the plurality of gate driving signals comprises:
adjusting a driving current utilized for generating one of the gate driving signals of each of the plurality of gate driving modules according to the plurality of gate driving signals, for adjusting the output resistance of each of the plurality of gate driving modules.

10. A driving device for a display system with a panel, the driving device comprising:
a plurality of gate driving modules, for generating a plurality of gate driving signals utilized for driving a plurality of scan lines of the panel; and
a control unit, for adjusting a plurality output resistances of the plurality of gate driving modules according to the plurality of gate driving signals.

11. The driving device of claim 10, wherein the control unit lowers the output resistance of a first gate driving module of the plurality of gate driving modules for a first period when a first gate driving signal generated by the first gate driving module enables a first scan line of the plurality of scan lines.

12. The driving device of claim 11, wherein the output resistance of the first gate driving module is lowered to a resistance of short circuit for the first period.

13. The driving device of claim 11, the control unit lowers the output resistance of a second gate driving module of the plurality of gate driving modules for a second period when a second gate driving signal generated by the second gate driving module disables a second scan line of the plurality of scan lines.

14. The driving device of claim 13, the output resistance of the second gate driving module is lowered to a resistance of short circuit for the second period.

15. The driving device of claim 13, wherein the control unit heightens the output resistances of a plurality of third gate driving modules among the plurality of gate driving modules and the plurality of third gate driving modules does not comprise the first gate driving module and the second gate driving module.

16. The driving device of claim 15, wherein the control unit heightens the output resistances of the plurality of third gate driving modules to resistances of open circuit.

17. The driving device of claim 10, wherein each of the plurality of gate driving modules comprises:
a gate driving unit, for generating one of the plurality of gate driving signals to an output end; and
a variable resistor, coupled between the output end and the gate driving unit;
wherein the control unit adjusts the output resistances of the plurality of gate driving modules via adjusting the variable resistors of the plurality of gate driving modules.

18. The driving device of claim 10, wherein the control unit adjusts the output resistances of the plurality of gate driving modules via adjusting driving currents utilized for generating the plurality of gate driving signals in the plurality of gate driving modules.
